(19) United States
(12) Patent Application Publication
(10) Pub. No.: US 2026/0343337 A1
(43) Pub. Date: Oct. 29, 2026

(54) CONDITIONAL ACCESS

(71) Applicant: Nokia Technologies Oy, Espoo (FI)

(72) Inventors: Ahmad AWADA, Munich (DE); Irina-Mihaela BALAN, Munich (DE); Ugur Baran ELMALI, Munich (DE); Guillaume DECARREAU, Munich (DE); Bernhard WEGMANN, Munich (DE)

(21) Appl. No.: 19/118,423

(22) PCT Filed: Oct. 6, 2023
(86) PCT No.: PCT/EP2023/077663

§ 371 Date: Apr. 4, 2025

(30) Foreign Application Priority Data
Oct. 10, 2022 (GB) 2214901.7

(51) Int. Cl. H04W 36/00; H04W 36/30; H04W 36/36

(52) U.S. Cl. CPC H04W 36/0058; H04W 36/0079; H04W 36/304; H04W 36/362; H04W 36/0094

(57) ABSTRACT

A user equipment comprising means for: transmitting information indicating whether at least one measurement report for at least one target primary cell of a secondary cell group of a target secondary node, detectable by the user equipment at a time that a secondary radio link failure occurred at the user equipment while the user equipment was configured to conditionally access the target secondary node, had been transmitted by the user equipment since the user equipment was configured to conditionally access the target secondary node and prior to the secondary radio link failure occurring.

### TECHNOLOGICAL FIELD

Examples of the disclosure relate to conditional access. Some relate to conditional access of a target secondary node.

### BACKGROUND

A wireless network comprises a plurality of network nodes including terminal nodes and access nodes. Communication between the terminal nodes and access nodes is wireless.

In some circumstances it may be desirable to improve or enhance conditional access, by a terminal node, of a target secondary node.

### BRIEF SUMMARY

According to various, but not necessarily all, embodiments there is provided a user equipment comprising means for:
transmitting information indicating whether at least one measurement report for at least one target primary cell of a secondary cell group of a target secondary node, detectable by the user equipment at a time that a secondary radio link failure occurred at the user equipment while the user equipment was configured to conditionally access the target secondary node, had been transmitted by the user equipment since the user equipment was configured to conditionally access the target secondary node and prior to the secondary radio link failure occurring.

In some examples, the user equipment comprises means for:
determining that the secondary radio link failure has occurred while the user equipment was configured to conditionally access the target secondary node;
determining the at least one detectable target primary cell of a secondary cell group of the target secondary node and associated radio signal measurements at the time of the secondary radio link failure; and
determining if the at least one measurement report for the at least one detectable target primary cell of a secondary cell group had been transmitted since the user equipment was configured to conditionally access the target secondary node and prior to the secondary radio link failure occurring.

In some examples, determining the at least one detectable target primary cell of a secondary cell group comprises determining N target primary cells of a secondary cell group having strongest radio signal measurements at the time of the secondary radio link failure, wherein N is a positive integer.

In some examples, transmitting the information comprises transmitting at least one SCG Failure Information message.

According to various, but not necessarily all, embodiments there is provided a method comprising:
transmitting, from a user equipment, information indicating whether at least one measurement report for at least one target primary cell of a secondary cell group of a target secondary node, detectable by the user equipment at a time that a secondary radio link failure occurred at the user equipment while the user equipment was configured to conditionally access the target secondary node, had been transmitted by the user equipment since the user equipment was configured to conditionally access the target secondary node and prior to the secondary radio link failure occurring.

In some examples, the method comprises:
determining that the secondary radio link failure has occurred while the user equipment was configured to conditionally access the target secondary node;
determining the at least one detectable target primary cell of a secondary cell group of the target secondary node and associated radio signal measurements at the time of the secondary radio link failure; and
determining if the at least one measurement report for the at least one detectable target primary cell of a secondary cell group had been transmitted since the user equipment was configured to conditionally access the target secondary node and prior to the secondary radio link failure occurring.

In some examples, determining the at least one detectable target primary cell of a secondary cell group comprises determining N target primary cells of a secondary cell group having strongest radio signal measurements at the time of the secondary radio link failure, wherein N is a positive integer.

In some examples, transmitting the information comprises transmitting at least one SCG Failure information message.

According to various, but not necessarily all, embodiments there is provided a computer program comprising instructions for causing an apparatus to perform at least the following:
transmitting, from a user equipment, information indicating whether at least one measurement report for at least one target primary cell of a secondary cell group of a target secondary node, detectable by the user equipment at a time that a secondary radio link failure occurred at the user equipment while the user equipment was configured to conditionally access the target secondary node, had been transmitted by the user equipment since the user equipment was configured to conditionally access the target secondary node and prior to the secondary radio link failure occurring.

In some examples, the computer program comprises instructions for causing an apparatus to perform at least:
determining that the secondary radio link failure has occurred while the user equipment was configured to conditionally access the target secondary node;
determining the at least one detectable target primary cell of a secondary cell group of the target secondary node and associated radio signal measurements at the time of the secondary radio link failure; and
determining if the at least one measurement report for the at least one detectable target primary cell of a secondary cell group had been transmitted since the user equipment was configured to conditionally access the target secondary node and prior to the secondary radio link failure occurring.

In some examples, determining the at least one detectable target primary cell of a secondary cell group comprises determining N target primary cells of a secondary cell group having strongest radio signal measurements at the time of the secondary radio link failure, wherein N is a positive integer.

In some examples, transmitting the information comprises transmitting at least one SCG Failure Information message.

According to various, but not necessarily all, embodiments there is provided an apparatus comprising means for:
receiving information indicating whether at least one measurement report for at least one target primary cell of a secondary cell group of a target secondary node, detectable by a user equipment at a time of secondary radio link failure occurring at the user equipment while the user equipment was configured to conditionally access the target secondary node, had been transmitted by the user equipment since the user equipment was configured to conditionally access the target secondary node and prior to the secondary radio link failure occurring; and
adjusting, based, at least in part, on the received information, at least one parameter configured to control a measurement event at a user equipment that triggers preparation of at least one target primary cell of a secondary cell group of the target secondary node for conditional access by the user equipment.

In some examples, the apparatus comprises means for:
transmitting information to configure a user equipment with the adjusted at least one parameter.

In some examples, transmitting the information comprises transmitting at least one RRC Reconfiguration message.

In some examples, receiving the information comprises receiving information indicating N target primary cells of a secondary cell group of the target secondary node having strongest radio signal measurements at the time of the secondary radio link failure, wherein N is a positive integer.

In some examples, receiving the information comprises receiving at least one SCG Failure Information message.

In some examples, the apparatus comprises means for:
determining, based, at least in part, on the received information, that the at least one measurement report had been transmitted by the user equipment for the at least one target primary cell of a secondary cell group of a target secondary node, detectable by the user equipment at the time of the secondary radio link failure occurring at the user equipment, and that the at least one target primary cell of a secondary cell group had not been prepared by the target secondary node for conditional access by the user equipment;
wherein adjusting the at least one parameter comprises adjusting the at least one parameter based, at least in part, on the determination.

In some examples, the apparatus comprises means for:
determining, based, at least in part, on the received information, that the at least one measurement report had not been transmitted by the user equipment for the at least one target primary cell of a secondary cell group of a target secondary node, detectable by a user equipment at the time of the secondary radio link failure occurring at the user equipment;
wherein adjusting the at least one parameter comprises adjusting the at least one parameter based, at least in part, on the determination.

According to various, but not necessarily all, embodiments there is provided a method comprising:
receiving information indicating whether at least one measurement report for at least one target primary cell of a secondary cell group of a target secondary node, detectable by a user equipment at a time of secondary radio link failure occurring at the user equipment while the user equipment was configured to conditionally access the target secondary node, had been transmitted by the user equipment since the user equipment was configured to conditionally access the target secondary node and prior to the secondary radio link failure occurring; and
adjusting, based, at least in part, on the received information, at least one parameter configured to control a measurement event at a user equipment that triggers preparation of at least one target primary cell of a secondary cell group of the target secondary node for conditional access by the user equipment.

In some examples, the method comprises:
transmitting information to configure a user equipment with the adjusted at least one parameter.

In some examples, transmitting the information comprises transmitting at least one RRC Reconfiguration message.

In some examples, receiving the information comprises receiving information indicating N target primary cells of a secondary cell group of the target secondary node having strongest radio signal measurements at the time of the secondary radio link failure, wherein N is a positive integer.

In some examples, receiving the information comprises receiving at least one SCG Failure Information message.

In some examples, the method comprises:
determining, based, at least in part, on the received information, that the at least one measurement report had been transmitted by the user equipment for the at least one target primary cell of a secondary cell group of a target secondary node, detectable by the user equipment at the time of the secondary radio link failure occurring at the user equipment, and that the at least one target primary cell of a secondary cell group had not been prepared by the target secondary node for conditional access by the user equipment;
wherein adjusting the at least one parameter comprises adjusting the at least one parameter based, at least in part, on the determination.

In some examples, the method comprises:
determining, based, at least in part, on the received information, that the at least one measurement report had not been transmitted by the user equipment for the at least one target primary cell of a secondary cell group of a target secondary node, detectable by the user equipment at the time of the secondary radio link failure occurring at the user equipment;
wherein adjusting the at least one parameter comprises adjusting the at least one parameter based, at least in part, on the determination.

According to various, but not necessarily all, embodiments there is provided a computer program comprising instructions for causing an apparatus to perform at least the following:
receiving information indicating whether at least one measurement report for at least one target primary cell of a secondary cell group of a target secondary node, detectable by a user equipment at a time of secondary radio link failure occurring at the user equipment while the user equipment was configured to conditionally access the target secondary node, had been transmitted by the user equipment since the user equipment was configured to conditionally access the target secondary node and prior to the secondary radio link failure occurring; and
adjusting, based, at least in part, on the received information, at least one parameter configured to control a measurement event at a user equipment that triggers preparation of at least one target primary cell of a secondary cell group of the target secondary node for conditional access by the user equipment.

In some examples, the computer program comprises instructions for causing an apparatus to perform at least:
transmitting information to configure a user equipment with the adjusted at least one parameter.

In some examples, transmitting the information comprises transmitting at least one RRC Reconfiguration message.

In some examples, receiving the information comprises receiving information indicating N target primary cells of a secondary cell group of the target secondary node having strongest radio signal measurements at the time of the secondary radio link failure, wherein N is a positive integer.

In some examples, receiving the information comprises receiving at least one SCG Failure Information message.

In some examples, the computer program comprises instructions for causing an apparatus to perform at least:
determining, based, at least in part, on the received information, that the at least one measurement report had been transmitted by the user equipment for the at least one target primary cell of a secondary cell group of a target secondary node, detectable by the user equipment at the time of the secondary radio link failure occurring at the user equipment, and that the at least one target primary cell of a secondary cell group had not been prepared by the target secondary node for conditional access by the user equipment;
wherein adjusting the at least one parameter comprises adjusting the at least one parameter based, at least in part, on the determination.

In some examples, the computer program comprises instructions for causing an apparatus to perform at least:
determining, based, at least in part, on the received information, that the at least one measurement report had not been transmitted by the user equipment for the at least one target primary cell of a secondary cell group of a target secondary node, detectable by the user equipment at the time of the secondary radio link failure occurring at the user equipment;
wherein adjusting the at least one parameter comprises adjusting the at least one parameter based, at least in part, on the determination.

According to various, but not necessarily all, embodiments there is provided an apparatus comprising;
at least one processor; and
at least one memory storing instructions that, when executed by the at least one processor, cause an apparatus at least to perform at least a part of one or more methods disclosed herein.

According to various, but not necessarily all, embodiments there is provided an apparatus comprising means for performing at least part of one or more methods disclosed herein.

According to various examples, but not necessarily all examples, there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

The description of a function should additionally be considered to also disclose any means suitable for performing that function.

### BRIEF DESCRIPTION

Some examples will now be described with reference to the accompanying drawings in which:

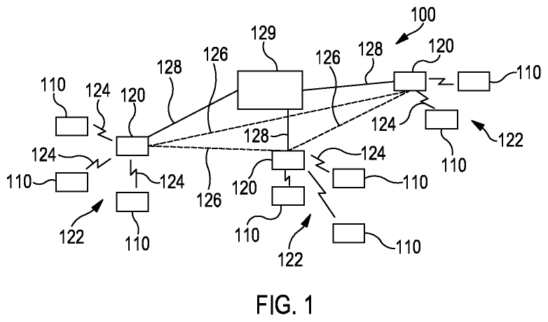

FIG. 1 shows an example of the subject matter described herein;

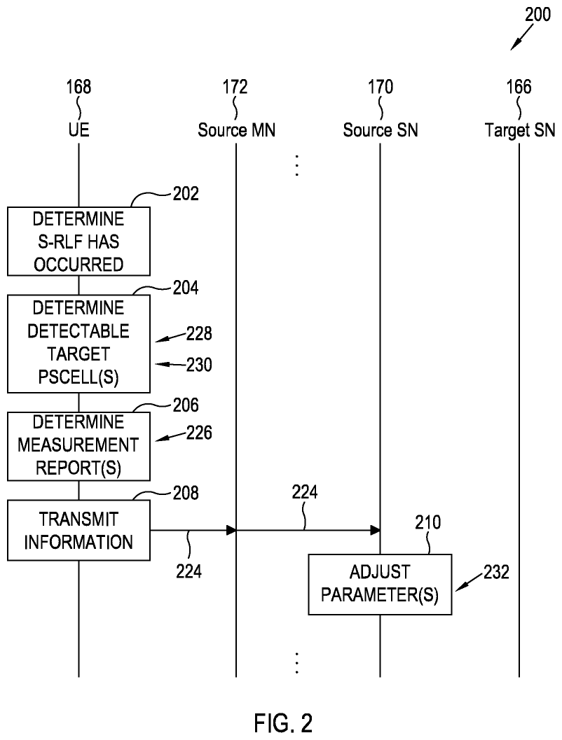

FIG. 2 shows another example of the subject matter described herein;

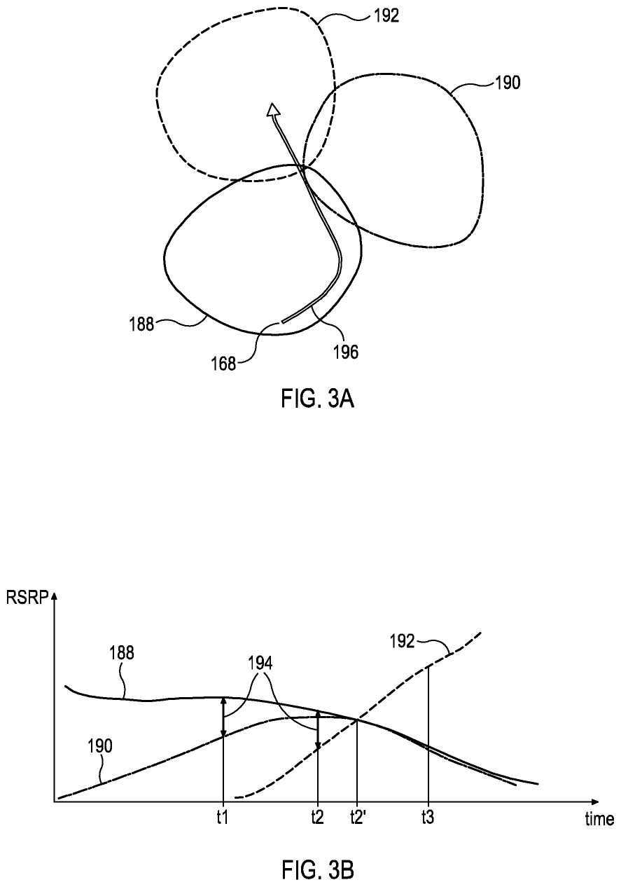

FIG. 3A shows another example of the subject matter described herein;

FIG. 3B shows another example of the subject matter described herein;

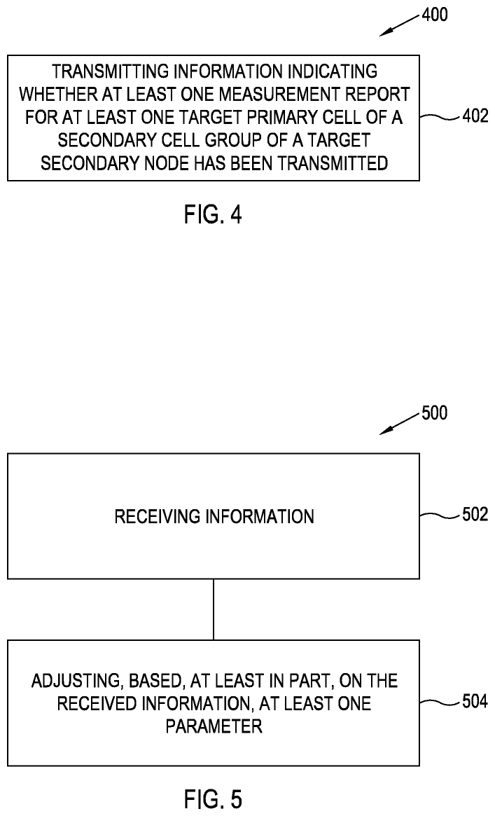

FIG. 4 shows another example of the subject matter described herein;

FIG. 5 shows another example of the subject matter described herein;

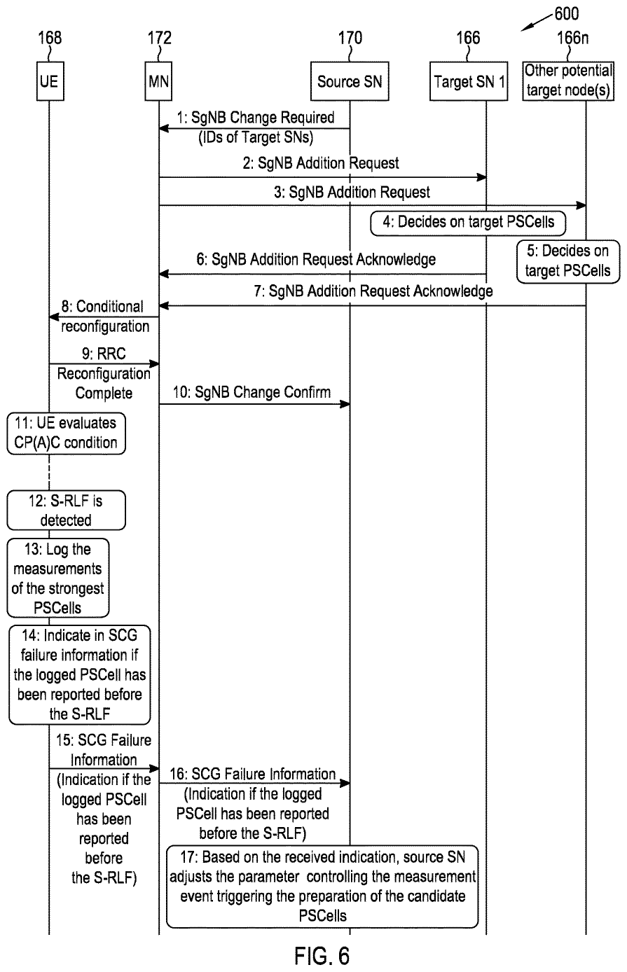

FIG. 6A shows another example of the subject matter described herein;

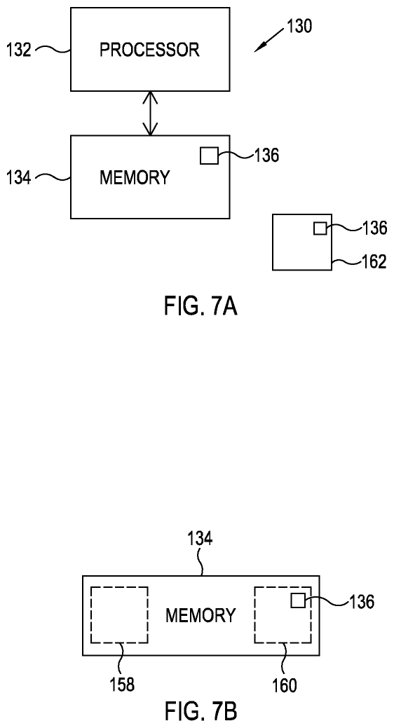

FIG. 7A shows another example of the subject matter described herein; and

FIG. 7B shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DEFINITIONS

Master Node (MN): Network node that provides control plane connectivity towards the core network.
Master Cell Group (MCG): Group of cells associated with the MN, includes PCell and SCell(s).
Secondary Node (SN): Network node that is providing additional radio resources for the UE but is not the MN.
Secondary Cell Group (SCG): Group of cells associated with the SN, includes PSCell and SCell(s).
PCell: The cell for uplink/downlink connection to MN. Cell of MCG used to initiate initial access to the MN.
PSCell: The cell for uplink/downlink connection to SN. Cell of SCG used to initiate initial access to the SN.
Conditional Handover (CHO)—a handover procedure that is triggered by the UE only when the configured execution condition(s) are met for a prepared candidate cell. Condition(s) are pre-configured by network. In 3GPP, a conditional handover execution condition is specified by condExecutionCond within the CondReconfigToAddModList information element within the ConditionalReconfiguration information element within an RRCReconfiguration message.
Dual Connectivity (DC):

UE has contemporaneous connection to an MN and an SN. This is a mode of operation of a UE in RRC_CONNECTED, configured with a Master Cell Group and a Secondary Cell Group.
Configuration Information:

Information used to configure operation of a UE. In 3GPP, the configuration information can, for example, be provided in an RRCReconfiguration message.

The term “configuration information comprising” an entity (for example handover execution condition for a primary cell; SN addition condition for dual connectivity with the primary cell and so on) can mean that the configuration information comprises information sufficient to obtain the entity. It may or may not comprise all parameters of the entity, it may instead comprise pointer to the entity or parameters of the entity or can mean that configuration includes the entity.

In 3GPP, a RRCReconfiguration message specifies a ConditionalReconfiguration information element which provides addition conditions for the DC. The ConditionalReconfiguration information element comprises a CondReconfigToAddModList information element. The CondReconfigToAddModList information element comprises condExecutionCond and condRRCReconfig. Addition condition(s) for a primary secondary cell (PSCell) are specified by condExecutionCond. The RRCReconfiguration message to be applied when the specified conditions are met is provided by condRRCReconfig.

### Measurement Configuration

Configuration information used to configure a UE to perform measurement(s). In 3GPP, the measurement configuration can, for example, be provided in an RRCReconfiguration message. The term “[entity] measurement configuration” (for example source primary cell measurement configuration) can mean a measurement configuration prepared by the entity.

Can comprise one or more measurement objects and one or more reporting configurations associated by one or more measurement identities.

Can comprise a MeasConfig information element as defined in TS 38.331.

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves/signals.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In examples the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other examples the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an Xn interface 126. The gNBs are also connected by means of the N2 interface 128 to the Access and Mobility management Function (AMF).

In examples, the network 100 can comprise a combination of E-UTRAN and NG-RAN.

A user equipment can comprise a mobile equipment. Where reference is made to user equipment that reference includes and encompasses, wherever possible, a reference to mobile equipment.

A UE 168 can perform a handover procedure to change the serving cell of the UE 168. In examples, a handover procedure can be a conditional handover procedure.

A conditional handover (CHO) procedure can be considered a handover that is triggered by the UE 168 when one or more handover execution conditions are met. The handover execution condition or conditions can be pre-configured by the network 100.

In examples, a UE 168 can be provided with additional radio resources using dual connectivity (DC).

In DC, the configured set of serving cells for a UE 168 has two subsets: the Master Cell Group (MCG) containing the serving cells of a Master Node (MN) 172, and the Secondary Cell Group (SCG) containing the serving cells of a Secondary Node (SN) 170.

In examples, a change of primary cell of secondary cell group (SCG) can be configured. A UE 168 can be configured with execution condition(s) for handover for performing an SN change to one or more target SN 166. Accordingly, a UE 168 can be configured to conditionally access one or more target SN 166.

In examples, an initiating node, for example a source MN 172 or source SN 170, can be configured to effectively and/or intelligently determine at least one parameter configured to control and/or involved in controlling a measurement event at a UE 168 that triggers preparation of at least one target primary cell of a secondary cell group (PSCell) of a target SN 166 for conditional access by the UE 168.

FIG. 2 illustrates an example of a method 200.

In examples, FIG. 2 can be considered to illustrate a plurality of methods. For example, FIG. 2 illustrates one or more actions at a plurality of actors/entities. In examples, FIG. 2 can be considered to illustrate a plurality of methods performed by the individual actors/entities.

One or more of the features discussed in relation to FIG. 2 can be found in one or more of the other FIGs.

In the example of FIG. 2, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 2 form at least a portion of a network 100 as described in relation to FIG. 1.

In the illustrated example, a terminal node 110, and three access nodes 120 can transmit and/or receive one or more signals and/or one or more messages. In the example of FIG. 2 the terminal node 110 is a UE 168 and the three access nodes 120 are a source MN 172, a Source SN 170, and a target SN 166.

In the example of FIG. 2, the UE 168 has dual connectivity with the source MN 172 and source SN 170. However, is some examples, the UE 168 does not have dual connectivity.

In the example of FIG. 2, the UE 168 is configured to conditionally access the target SN 166.

The UE 168 can be configured to conditionally access the target SN 166 in any suitable way, using any suitable method. For example, the UE 168 can receive any suitable configuration information to configure the UE 168 to access the target SN 166 upon fulfillment of at least one criterion.

In examples, the UE 168 is configured with at least one CPAC configuration. For example, the UE 168 can be configured with at least one CPC or CPA configuration.

In examples, accessing a PSCell, or any other suitable cell, comprises performing a random access procedure with the cell.

In examples, accessing a PSCell, or any other suitable cell, comprises establishing a connection with the cell.

In examples, communications and/or transmissions between elements illustrated in FIG. 2 can proceed via any number of intervening elements, including no intervening elements.

Although one UE 168 is illustrated in the example of FIG. 2, in examples any suitable number of UEs 168 can be included.

Similarly, in examples, any suitable number of network nodes can be included.

In examples, method 200 and/or at least part of method 200 can be considered a method of enhancing conditional access of a target SN.

In examples, method 200 and/or at least part of method 200 can be considered a method of enhancing or improving measurement reporting by a UE.

In examples, method 200 and/or at least part of method 200 can be considered a method of enhancing or improving determination of parameters for configuration of a UE to conditionally access a target SN.

In the illustrated example, the location of the blocks indicates the entity performing the action(s). For example, block 202 is performed at/by the UE 168.

In examples, method 200 is part of a method to configure, and/or allow, and/or enable a UE 168 to conditionally access at least one target SN 166. In some examples, method 200 is part of a conditional PSCell addition and Change (CPAC) method/process/procedure. For example, method 200 can be part of a conditional PSCell Change (CPC) method/process/procedure or a conditional PSCell Addition (CPA) method/process.

In some examples, method 200 can be considered to be SN initiated. That is, in some examples, method 200 can be initiated by and/or involve a source SN 170. For example, method 200 can be part of an SN initiated CPAC method/process/procedure.

In the illustrated example, method 200 is SN initiated and block 210 is performed by the source SN, and block 208 involves the source SN 170.

In some examples, method 200 can be considered to be MN initiated. That is, in some examples, method 200 can be initiated by a source MN 172 and/or be without involvement of a source SN 170. For example, method 200 can be part of an MN initiated CPAC method/process/procedure.

In such examples, block 210 is performed at/by the source MN 172 and block 208 does not involve the source SN 170.

At block 202, method 200 comprises determining that a secondary radio link failure (S-RLF) has occurred while a UE 168 was configured to conditionally access a target SN 166.

Determining that a S-RLF has occurred can be performed in any suitable way, using any suitable method.

The S-RLF can be any type of S-RLF occurring for any suitable reason. For example, the S-RLF can occur while connected to a source SN 170, or in performing random access to a target PSCell and so on.

In examples, a UE 168 can be considered to be configured to conditionally access a target SN 166 when the UE 168 has received and/or applied configuration information to configure the UE 168 to access the target SN 166 upon fulfillment of at least one criterion.

In examples, the UE 168 can be considered to be configured to conditionally access a target SN 166 when the UE 168 is configured with at least one CPAC configuration, for example when the UE 168 is configured with at least one CPC or CPA configuration.

By way of example, reference is made to the example of FIG. 3.

FIG. 3A illustrates an example scenario. In the example of FIG. 3 a UE 168 is located within and is being served by a source PSCell 188.

In the illustrated example, the UE 168 moves along the trajectory 196 and as the UE 168 moves along the trajectory 196 the UE detects two PSCells, PSCell1 190 and PSCell2 192.

FIG. 3B illustrates a plot of reference signal received power (RSRP) for the source PSCell 188, PSCell1 190, and PSCell2 192 as the UE 168 moves along the trajectory 196 shown in the example of FIG. 3A.

With regard to the plot shown in the example of FIG. 3B, at time t1 PSCell1 190 reaches a measurable signal strength that fulfills the RSRP offset 194 configured at the UE 168 and triggers a preparation of PSCell1 190 as candidate cell for conditional access by the UE 168, such as CPC.

At time t2 PSCell2 192 also fulfils the RSRP offset 194 preparation criterion configured at the UE 168 and a measurement event report is sent from the UE 168 to the source PSCell 188, which in turn triggers, for example, a SgNB (Conditional) Change Required message to MN and, for example, a SgNB (Conditional) Addition Request message from MN to target SN including measurement results of the target PSCell1 190 and PSCell2 192.

In the illustrated example, the target SN may decide on the preparation of target PSCell1 190, as target PSCell1 190 has the best received measurement.

However, later on in the example of FIG. 3B, at time instance t3, the UE 168 experiences a secondary radio link failure on the currently serving PSCell and sends S-RLF Failure Information to MN.

In the illustrated example, the target SN misses the preparation of target PSCell2 192 which results in an S-RLF in the source PSCell 188, because the conditional access execution criterion for the prepared PSCell1 190 was not reached.

FIG. 3A and FIG. 3B can be considered to illustrate and S-RLF and the circumstances of the S-RLF experienced by the UE 168.

In the example of FIG. 3, the preparation of the target PSCells 190, 192 was too early when measurements did not reflect the actual radio conditions at the time of conditional access execution. Accordingly, in the example of FIG. 3, the S-RLF could have been avoided if parameter(s) controlling a measurement event at the UE that triggers preparation of the target PSCell(s) had been adjusted/different.

Returning to the example of FIG. 2, at block 204, method 200 comprises determining at least one detectable target PSCell 228 of the target SN 166 and associated radio signal measurements at the time of the S-RLF. Radio signal measurements can comprise radio signal power measurements.

Determining at least one detectable target PSCell 228 of the target SN 166 and associated radio signal measurements at the time of the S-RLF can be performed in any suitable way using any suitable method.

In examples, a detectable target PSCell 228 is a target PSCell 228 from which a UE 168 can receive at least one signal.

In examples, a detectable target PSCell 228 is a target PSCell 228 for which a UE 168 can determine at least one radio signal measurement.

In examples, a detectable target PSCell 228 is a target PSCell from which a UE 168 can receive at least one signal having a received signal power greater than or equal to a value. Any suitable value can be used.

In some examples, a detectable target PSCell 228 is a target PSCell from which a UE 168 can receive at least one signal having a received signal power greater than or equal to −156 dBm.

A detectable target PSCell 228 can be considered a measurable target PSCell, and/or a discernable target PSCell, and/or an observable target PSCell, and/or a distinguishable target PSCell, and/or a perceptible target PSCell and so on.

A detectable target PSCell 228 can be considered a target PSCell detectable by the UE 168 at the time that a S-RLF occurred.

A radio signal measurement 230 can comprise any suitable measurement or measurements. For example, a radio signal measurement 230 can comprise any suitable measurement or measurements indicative of radio power of at least one signal received from a target SN 166, and/or from a target PSCell, and/or in relation to a target PSCell.

In examples, a radio signal measurement 230 comprises at least one received signal received power (RSRP) and/or at least one reference signal received quality (RSRQ), and/or at least one signal to interference and noise ratio (SINR) measurement.

In examples, a radio signal measurement 230 can be considered associated with a target PSCell of a target SN 166 because the radio signal measurement 230 is performed on and/or in relation to at least one signal received from the target PSCell of a target SN 166.

In examples, a radio signal measurement 230 can be considered associated with a target PSCell of a target SN 166 because the radio signal measurement indicates the power, for example, of at least one received radio signal from the target PSCell.

In examples, at the time of the S-RLF includes a period before, and/or after, and/or around the time that the S-RLF occurs. Accordingly, in examples, at the time of the S-RLF includes a period of time before the S-RLF occurs and/or a period of time after the S-RLF occurs.

Any suitable period of time before and/or after the S-RLF occurs can be used. For example, any suitable period of time that provides adequate information regarding the at least one detectable target PSCell 228 of the target SN 166 and associated radio signal measurements.

For example, a period of time in the range 1 seconds to 30 minutes can be used.

For example, a period of time in the range 30 seconds to 20 minutes can be used.

For example, a period of time in the range 1 minute to 15 minutes can be used.

For example, a period of time in the range 5 minutes to 10 minutes can be used.

In examples, the period of time can be at least Z microseconds, wherein Z is a positive integer.

In examples, the period of time can be at least Y milliseconds, wherein Y is a positive integer.

In examples, the period of time can be at least M seconds, wherein M is a positive integer.

In examples, the period of time can be at least X minutes, wherein X is a positive integer.

Accordingly, in examples, block 204 can be considered to comprise determining at least one detectable target PSCell 228 of the target SN 166 and associated radio signal measurements in a time period including the time that the S-RLF occurred.

In examples, block 204 comprises determining at least one target PSCell from which the UE 168 can receive at least one signal and determining at least one radio signal measurement for each of at least one target PSCell.

For example, in the example of FIG. 3, the UE 168 can determine that target PSCell1 190 and target PSCell2 192 are detectable at the time of S-RLF, and can determine associated radio signal measurements 230 for PSCell1 190 and PSCell2 192 at the time of the S-RLF occurring.

In some examples, determining at least one detectable target PSCell 228 comprises determining N target PSCells having strongest radio signal measurements at the time of the S-RLF, wherein N is a positive integer.

N can be any suitable positive integer. For example, N can be in the range 1 to 64.

For example, in the example of FIG. 3, if N is equal to 1, the UE 168 would determine PSCell2 192, as PSCell2 192 has the strongest radio signal measurement(s) at the time of the S-RLF.

At block 206, method 200 comprises determining if at least one measurement report 226 for the at least one detectable target PSCell 228 had been transmitted since the UE 168 was configured to conditionally access the target SN 166 and prior to the S-RLF occurring.

In examples, block 206 comprises determining if at least one measurement report 226 for the at least one detectable target PSCell 228 had been reported to the network, for example a network node such as a source MN 172 or source SN 170, since the UE 168 was configured to conditionally access the target SN 166 and prior to the S-RLF occurring.

In examples, block 206 comprises determining if at least one measurement report 226 for the at least one detectable target PSCell 228 had been transmitted to the network, for example to a source MN 172 or source SN 170, since the UE 168 was configured to conditionally access the target SN 166 and prior to the S-RLF occurring.

Block 206 can be performed in any suitable way using any suitable method.

In examples, at block 206, the UE 168 determines from logged/stored information whether the UE 168 had transmitted/reported at least one measurement report 226 for the at least one detectable target PSCell 228 in the time period between the UE 168 being configured to conditionally access the target SN 166 and the S-RLF occurring.

For example, the UE 168 can determine from logged/stored information whether the UE 168 had transmitted/reported at least one measurement report 226 for the at least one detectable target PSCell 228 in the time period between the UE 168 being configured to conditionally access the target SN 166 and the S-RLF occurring.

For example, in the example of FIG. 3, the UE 168 would determine if the UE 168 had reported/transmitted at least one measurement report 226 for PSCell1 190 and PSCell2 192 since the UE 168 was configured to conditionally access the target SN 166 and prior to the S-RLF occurring.

A measurement report can be considered any suitable indication of one or more measurements made by the UE 168. In examples, a measurement report comprises an indication of at least one radio signal measurement for at least one target PSCell.

In examples, a measurement report can comprise a measurement report as defined in 3GPP TS 38.331.

At block 208, method 200 comprises transmitting information 224 indicating whether at least one measurement report 226 for at least one target PSCell 228 of a target SN 166, detectable by the UE 168 at a time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring.

Consequently. FIG. 2 illustrates a method 200 comprising:
transmitting information 224 indicating whether at least one measurement report 226 for at least one target PSCell 228 of a target SN 166, detectable by the UE 168 at the time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring.

Information 224 indicating whether at least one measurement report 226 for at least one target PSCell 228 of a SN 166, detectable by the UE 168 at the time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring can comprise any suitable information.

For example, information 224 can comprise any suitable information to allow a network node, such as a source SN 172 or a source MN 170, to determine for each of the target PSCell(s) 228 of a SN 166, detectable by the UE 168 at the time of the S-RLF, whether at least one measurement report had been sent by the UE 168 while the UE 168 was configured to conditionally access the target SN 166 and prior to the S-RLF occurring.

In examples, the information 224 can comprise a value for each of the detectable target PSCell(s) 228 indicating the number of measurement reports sent by the UE 168 for each of the detectable target PSCell(s) 228 while the UE 168 was configured to conditionally access the target SN 166 and prior to S-RLF occurring.

In examples, the information 224 can comprise a binary indicator for each of the detectable target PSCell(s) 228 indicating whether or not at least one measurement report 226 was sent by the UE 168 while the UE 168 was configured to conditionally access the target SN 166 and prior to S-RLF occurring.

In some examples, method 200 comprises transmitting the associated radio signal measurements for the at least one detectable target PSCell 228. The associated radio signal measurements for the at least one detectable target PSCell 228 can be transmitted with information 224 at block 208.

Block 208 can be performed in any suitable way using any suitable method. In examples, transmitting information 224 at block 208 comprises transmitting at least one signal and/or message.

In some examples, transmitting information 224 comprises transmitting at least one SCG Failure Information message.

The information 224 can be transmitted at block 208 can be transmitted to any suitable network node, for example a source MN 172 or a source SN 170. Accordingly, in some examples, transmitting information 224 comprises transmitting information 224 to the source MN 172 or source SN 170.

In examples, from the point of view of the source SN 170, or source MN 172, block 208 comprises receiving information 224 indicating whether at least one measurement report 226 for at least one target PSCell 228 of a target SN 166, detectable by a UE 168 at the time of the S-RLF occurring at the UE 168 while the UE 168 was configured to conditionally access the target SN 166, had been transmitted by the UE 168 since the UE was configured to conditionally access the target SN and prior to the S-RLF occurring.

In examples, from the point of view of the source SN 170, or source MN 172, receiving information 224 comprises receiving information 224 indicating N target PSCells of the target SN 166 having strongest radio signal measurements at the time of the S-RLF, wherein N is a positive integer.

In examples, receiving information 224 comprises receiving at least one SCG Failure Information message.

In examples, information 224 can be received from any suitable number of different UEs 168.

In examples, information 224 can be received, and/or collected, over any suitable time period. For example, the information 224 can be received from a plurality of UEs 168 over a time period long enough to allow sufficient information 224 to be received to allow method 200 to be performed. For example, the information 224 can be received over a time period long enough to allow sufficient information 224 to be received to allow at least one parameter 232 to be adjusted at block 204.

In examples, the time period can be 2 to 3 hours, half a day, a day, 2 to 3 days, a week, 2 to 3 weeks, a month and so on.

In examples, the information 224 can be received over a Key Performance Indicator (KPI) collection period.

At block 210, method 200 comprises adjusting, based, at least in part, on the received information 224, at least one parameter 232 configured to control a measurement event at a UE 168 that triggers preparation of at least one target PSCell of the target SN 166 for conditional access by the UE 168.

Consequently, FIG. 2 illustrates a method 200 comprising:
receiving information 224 indicating whether at least one measurement report 226 for at least one target PSCell 228 of a target SN 166, detectable by a UE 168 at the time of the S-RLF occurring at the UE 168 while the UE 168 was configured to conditionally access the target SN 166, had been transmitted by the UE 168 since the UE was configured to conditionally access the target SN and prior to the S-RLF occurring; and
adjusting, based, at least in part, on the received information 224, at least one parameter 232 configured to control a measurement event at a UE 168 that triggers preparation of at least one target PSCell of the target SN 166 for conditional access by the UE 168.

Adjusting at least one parameter 232 can be considered changing, and/or altering, and/or modifying, and/or tuning, and/or adapting at least one parameter 232 and so on.

Block 210 can be performed in any suitable way using any suitable method.

In examples, adjusting, based, at least in part, on the received information 224, at least one parameter 232 comprises adjusting, based, at least in part, on the received information 224, at least one parameter 232 configured to control a measurement event at a UE 168 that triggers preparation of at least one target PSCell of the target SN 166 for conditional access by the UE 168 so that the target SN 166 receives relevant radio measurements for preparation of the at least one target PSCell. For example, radio measurements that more accurately reflect the radio situation at the time of at least one previous S-RLF.

In examples, adjusting, based, at least in part, on the received information 224, at least one parameter 232 comprises adjusting, based, at least in part, on the received information 224, at least one parameter 232 configured to control a measurement event at a UE 168 that triggers preparation of at least one target PSCell of the target SN 166 for conditional access by the UE 168 so that the measurement event occurs at a time when the radio measurements for the strongest detectable target PSCells 228 indicated in information 224 would reflect the situation when at least one previous S-RLF occurred.

That is, in examples, the at least one parameter 232 is adjusted to cause, for a UE 168 in similar circumstances as at least one UE 168 from which information 224 is received, the measurement event that triggers preparation of at least one target PSCell of the target SN 166 for conditional access by the UE 168 to be earlier or later to allow an S-RLF to be avoided.

For example, in the example of FIG. 3, the at least one parameter, such as A3_prep_offset, can be adjusted so that the measurement event that triggers preparation of the target PSCells occurs after time t2′, at which time PSCell2 192 has the strongest radio measurements, allowing PSCell2 192 to be prepared for conditional access by a UE 168 and avoiding an S-RLF occurring for a UE 168 in similar circumstances.

In examples, it can be assumed that statistics collected over a collection period remain approximately constant. For example, users usually move on fixed, street pedestrian lanes that are deterministic and not random.

In examples, adjusting at least one parameter 232 comprises adjusting at least one parameter in configuration information for a UE 168. For example, adjusting at least one parameter 232 can comprise adjusting at least one of the offset, hysteresis, Time-to-Trigger (TTT) of an A3 measurement event.

For example, adjusting at least one parameter 232 can comprises adjusting at least one of the threshold, hysteresis, TTT of an A4, and/or A5, and/or B1 measurement event.

In some examples, adjusting at least one parameter 232 comprises transmitting information to configure a UE 168 with the adjusted at least one parameter 232.

The UE 168 can be a UE 168 from which information 224 has been received or can be a UE 168 from which information 224 has not been received.

Transmitting information to configure a UE 168 with the adjusted at least one parameter 232 can be performed in any suitable way using any suitable method.

In examples, transmitting information to configure a UE 168 with the adjusted at least one parameter 232 comprises transmitting configuration information.

In some examples, transmitting information to configure a UE 168 with the adjusted at least one parameter 232 comprises transmitting at least one RRC Reconfiguration message.

In examples, adjusting at least one parameter 232 at block 210 comprises using a mobility robustness optimization algorithm, and/or artificial intelligence, and/or machine learning technique(s).

Any suitable parameter or parameters 232 can be adjusted. For example, any suitable parameter or parameters 232 configured to control a measurement event at a UE 168 that triggers preparation of at least one PSCell of a target SN 166 for conditional access by the UE 168 can be adjusted.

For example, the parameter(s) can comprise offset, hysteresis, threshold(s), and/or TTT and so on.

In examples, the measurement event at a UE 168 that triggers preparation of the at least one PSCell can comprise any suitable measurement event. For example, the measurement event can comprise an A3, A4, A5 and/or B1 measurement event and so on.

In examples, the measurement event at a UE 168 that triggers preparation of the at least one PSCell comprises a measurement event that causes the UE 168 to transmit at least one signal and/or message, for example to a source MN 172 or source SN 170, that causes preparation of at least one target PSCell.

For example, the measurement event at a UE 168 can cause the UE 168 to transmit at least one MeasurementReport message, for example to a source MN 172 or source SN 170.

For example, the measurement event at a UE 168 can comprise a measurement event at a UE 168 that causes the UE 168 to transmit at least one measurement report.

In examples, the measurement event at a UE 168 can comprise a measured signal strength for at least one target PSCell being within a predetermined value of a measured signal strength of a source PScell.

In some examples, the measurement event at a UE 168 can comprise a measured signal strength for at least one target PScell being higher than a threshold.

In some examples, the measurement event at a UE 168 can comprise a measured signal strength for at least one target PScell being higher than a threshold and a measured signal strength for the source PScell being smaller than another threshold.

In some examples, method 200 comprises determining, by a source SN 170 or source MN 172, based, at least in part, on the received information 224, that at least one measurement report 226 had been transmitted by the UE 168 for at least one target PScell 228 of a target SN 166, detectable by the UE at the time of S-RLF occurring at the UE 168, and that the at least one target PSCell 228 had not been prepared by the target SN 166 for conditional access by the UE 168; wherein adjusting at least one parameter 232 comprises adjusting at least one parameter 232 based, at least in part, on the determination.

In examples, the source SN 170 or source MN 172 can determine that the at least one target PSCell 228 had not been prepared by the target SN 166 for conditional access by a UE 168 in any suitable way using any suitable method.

In examples, the source SN 170 or source MN 172 can receive information indicative of whether the target SN 166 had been prepared for conditional access by the UE 168. For example, the source SN 170 or source MN 172 can receive (or not receive) conditional access configuration information for the target PSCell 228.

If it is determined, based, at least in part, on the received information 224, that at least one measurement report 226 had been transmitted by the UE 168 for at least one detectable target PSCell 228 at the time of S-RLF occurring at the UE 168, and that the at least one target PSCell 227 had not been prepared by the target SN 166 for conditional access by the UE 168, the at least one parameter 232 can be adjusted in any suitable way.

For example, the at least one parameter 232 can be adjusted so that a UE 168 in similar circumstances performs the measurement event that triggers preparation of at least one PSCell at the target SN 166 later.

This is advantageous, for example, in examples such as the example of FIG. 3A.

In some examples, method 200 comprises determining, by a source SN 170 or source MN 172, based, at least in part, on the received information 224, that at least one measurement report 226 had not been transmitted by the UE 168 for at least one target PSCell 228 of a target SN 166, detectable by the UE 168 at the time of S-RLF occurring at the UE 168; wherein adjusting at least one parameter 232 comprises adjusting at least one parameter 232 based, at least in part, on the determination.

If it is determined, based, at least in part, on the received information 224, that at least one measurement report 226 had not been transmitted by the UE 168 for at least one target PSCell 228 of a target SN 166, detectable by the UE 168 at the time of S-RLF occurring at the UE 168 the at least one parameter 232 can be adjusted in any suitable way.

For example, the at least one parameter 232 can be adjusted so that a UE 168 in similar circumstances performs the measurement event that triggers preparation of at least one PSCell at the target SN 166 earlier.

This is advantageous, for example, in examples of fast degradation in the serving/source PSCell radio link quality, such that the measurement event did not trigger transmission of a measurement report.

In examples, method 200 can then proceed according to a conditional access method/process/procedure using the adjusted parameter(s) at a UE 168 to cause the UE 168 to trigger preparation of at least one target PSCell for conditional access by the UE 168, and to configure the UE 168 to conditionally access the target SN 166.

For example, method 200 can then proceed according to a CPAC method/process/procedure, such as a CPA or CPC method/process/procedure. See, for example, FIGS. 6A and 6B.

In examples, method 200 can be repeated any suitable number of times.

As previously noted, examples can make use of mobility robustness optimization algorithm(s). In this regard, Self-Organizing Networks (SONs) are networks that are able to automatically adjust the radio network parameters based on the collected statistics from the network. Mobility Robustness Optimization (MRO) is an example of SON which, in examples, deals with the adjustment of the parameters controlling the cell change (for example the change of PSCell).

In MRO, the network collects, in examples, statistics for a certain period of time (failure report can be one of them), denoted by, for example, KPI collection period. In each KPI collection period, for example, the KPI statistics are processed by the network and decisions are taken to make changes. The network applies the changes, for example to assistance information, and collects new statistics with the changes in, for example, a new KPI collection period.

This process can be repeated by the network until it reaches a KPI collection period where it decides that nothing needs to be done (for example, the problem is solved or tuning the threshold/offset is no longer possible).

At this case, it can be considered that MRO has converged. In examples, the values of performance metrics, collected in each of KPI collection period, should be statistically significant (high number of statistics) to have reliable network decisions when making changes.

Examples of the disclosure are advantageous and provide technical benefits.

For example, examples of the disclosure allow triggering of preparation of target PSCell(s) to be intelligently controlled to avoid S-RLFs.

For example, examples of the disclosure reduce radio link failures caused by preparing the wrong candidate PSCells.

FIG. 4 illustrates an example of a method 400.

In examples, method 400 can be performed by any suitable apparatus comprising any suitable means for performing method 400. For example, an apparatus as described in relation to FIGS. 7A and/or 7B.

In examples, method 400 can be performed by a UE 168, such as a UE 168 of FIG. 2.

At block 402, method 400 comprises transmitting information 224 indicating whether at least one measurement report 226 for at least one target PSCell 228 of a target SN 166, detectable by the UE 168 at a time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring.

Consequently, FIG. 4 illustrates a method 400 comprising:
transmitting information 224 indicating whether at least one measurement report 226 for at least one target PSCell 228 of a target SN 166, detectable by the UE 168 at a time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring.

FIG. 5 illustrates an example of a method 500.

In examples, method 500 can be performed by any suitable apparatus comprising any suitable means for performing method 500. For example, an apparatus as described in relation to FIGS. 7A and/or 7B.

In examples, method 500 can be performed by a source SN 170, such as a source SN 170 of FIG. 2.

In examples, method 500 can be performed by a source MN 172, such as a source MN 172 of FIG. 2.

At block 502, method 500 comprises receiving information 224 indicating whether at least one measurement report 226 for at least one target PSCell 228 of a target SN 166, detectable by a UE 168 at the time of the S-RLF occurring at the UE 168 while the UE 168 was configured to conditionally access the target SN 166, had been transmitted by the UE 168 since the UE was configured to conditionally access the target SN and prior to the S-RLF occurring.

At block 504, method 500 comprises adjusting, based, at least in part, on the received information 224, at least one parameter 232 configured to control a measurement event at a UE 168 that triggers preparation of at least one target PSCell of the target SN 166 for conditional access by the UE 168.

Consequently, FIG. 5 illustrates a method 500 comprising:
receiving information 224 indicating whether at least one measurement report 226 for at least one target PSCell 228 of a target SN 166, detectable by a UE 168 at the time of the S-RLF occurring at the UE 168 while the UE 168 was configured to conditionally access the target SN 166, had been transmitted by the UE 168 since the UE was configured to conditionally access the target SN and prior to the S-RLF occurring; and
adjusting, based, at least in part, on the received information 224, at least one parameter 232 configured to control a measurement event at a UE 168 that triggers preparation of at least one target PSCell of the target SN 166 for conditional access by the UE 168.

FIG. 6 illustrates an example of a method 600.

Some examples relate to third generation Partnership Project (3GPP) network. FIG. 6 can be considered to illustrate some such examples.

The following description can be considered to illustrate some such examples.

In the example of FIG. 6, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 6 form at least a portion of a network 100 as described in relation to FIG. 1.

In the illustrated example, a terminal node 110, and four or more access nodes 120 transmit and/or receive one or more signals and/or one or more messages. In the example of FIG. 2 the terminal node 110 is a UE 168 and the four or more access nodes 120 are a source MN 172, a Source SN 170, a target SN 166 and other potential target node(s) 166n.

In the example of FIG. 6, the UE 168 has dual connectivity with the source MN 172 and source SN 170.

In examples, communications and/or transmissions between elements illustrated in FIG. 6 can proceed via any number of intervening elements, including no intervening elements.

Although one UE 168 is illustrated in the example of FIG. 6, in examples any suitable number of UEs 168 can be included.

Similarly, in examples, any suitable number of network nodes can be included.

A high-level flow chart is shown in FIG. 6.

FIG. 7A illustrates an example of an apparatus 130. The apparatus 130 may be a controller of an apparatus of device such as a terminal node 110, for example a UE 168, or network element 172, 170, and/or 166, such as an eNB or gNB. The apparatus 130 may be considered a controller.

Implementation of a 130 may be as controller circuitry. The controller 130 may be implemented in hardware alone, have certain aspects in software including firmware alone or can be a combination of hardware and software (including firmware).

As illustrated in FIG. 7A the controller 130 may be implemented using instructions that enable hardware functionality, for example, by using executable instructions of a computer program 136 in a general-purpose or special-purpose processor 132 that may be stored on a computer readable storage medium (disk, memory etc) to be executed by such a processor 132.

The processor 132 is configured to read from and write to the memory 134. The processor 132 may also comprise an output interface via which data and/or commands are output by the processor 132 and an input interface via which data and/or commands are input to the processor 132.

The memory 134 stores a computer program 136 comprising computer program instructions (computer program code) that controls the operation of the apparatus 130 when loaded into the processor 132. The computer program instructions, of the computer program 136, provide the logic and routines that enables the apparatus to perform the methods illustrated in the accompanying Figs. The processor 132 by reading the memory 134 is able to load and execute the computer program 136.

In examples, the apparatus 130 comprises:
at least one processor 132; and
at least one memory 134 including computer program code
the at least one memory 134 and the computer program code configured to, with the at least one processor 132, cause the apparatus 130 at least to perform:
transmitting information 224 indicating whether at least one measurement report 226 for at least one target PSCell 228 of a target SN 166, detectable by the UE 168 at a time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring.

In examples, the apparatus 130 comprises:
at least one processor 132; and
at least one memory 134 including computer program code
the at least one memory 134 and the computer program code configured to, with the at least one processor 132, cause the apparatus 130 at least to perform:
receiving information 224 indicating whether at least one measurement report 226 for at least one target PSCell 228 of a target SN 166, detectable by a UE 168 at the time of the S-RLF occurring at the UE 168 while the UE 168 was configured to conditionally access the target SN 166, had been transmitted by the UE 168 since the UE was configured to conditionally access the target SN and prior to the S-RLF occurring; and
adjusting, based, at least in part, on the received information 224, at least one parameter 232 configured to control a measurement event at a UE 168 that triggers preparation of at least one target PSCell of the target SN 166 for conditional access by the UE 168.

In examples, the apparatus 130 comprises:
at least one processor 132; and
   at least one memory 134 including computer program code,
      the at least one memory storing instructions that, when executed by the at least one processor 132, cause the apparatus at least to:
transmitting information 224 indicating whether at least one measurement report 226 for at least one target PSCell 228 of a target SN 166, detectable by the UE 168 at a time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring.

In examples, the apparatus 130 comprises:
at least one processor 132; and
   at least one memory 134 including computer program code,
      the at least one memory storing instructions that, when executed by the at least one processor 132, cause the apparatus at least to:
receiving information 224 indicating whether at least one measurement report 226 for at least one target PSCell 228 of a target SN 166, detectable by a UE 168 at the time of the S-RLF occurring at the UE 168 while the UE 168 was configured to conditionally access the target SN 166, had been transmitted by the UE 168 since the UE was configured to conditionally access the target SN and prior to the S-RLF occurring; and adjusting, based, at least in part, on the received information 224, at least one parameter 232 configured to control a measurement event at a UE 168 that triggers preparation of at least one target PSCell of the target SN 166 for conditional access by the UE 168.

As illustrated in FIG. 7A, the computer program 136 may arrive at the apparatus 130 via any suitable delivery mechanism 162. The delivery mechanism 162 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 136. The delivery mechanism may be a signal configured to reliably transfer the computer program 136. The apparatus 130 may propagate or transmit the computer program 136 as a computer data signal.

Computer program instructions for causing an apparatus to perform at least the following or for performing at least the following:
transmitting information 224 indicating whether at least one measurement report 226 for at least one target PSCell 228 of a target SN 166, detectable by the UE 168 at a time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring.

Computer program instructions for causing an apparatus to perform at least the following or for performing at least the following:
receiving information 224 indicating whether at least one measurement report 226 for at least one target PSCell 228 of a target SN 166, detectable by a UE 168 at the time of the S-RLF occurring at the UE 168 while the UE 168 was configured to conditionally access the target SN 166, had been transmitted by the UE 168 since the UE was configured to conditionally access the target SN and prior to the S-RLF occurring; and
adjusting, based, at least in part, on the received information 224, at least one parameter 232 configured to control a measurement event at a UE 168 that triggers preparation of at least one target PSCell of the target SN 166 for conditional access by the UE 168.

The computer program instructions may be comprised in a computer program, a non-transitory computer readable medium, a computer program product, a machine readable medium. In some but not necessarily all examples, the computer program instructions may be distributed over more than one computer program.

Although the memory 134 is illustrated as a single component/circuitry it may be implemented as one or more separate components/circuitry some or all of which may be integrated/removable and/or may provide permanent/semi-permanent/dynamic/cached storage.

In examples the memory 134 comprises a random access memory 158 and a read only memory 160. In examples the computer program 136 can be stored in the read only memory 158. See, for example, FIG. 7B.

Although the processor 132 is illustrated as a single component/circuitry it may be implemented as one or more separate components/circuitry some or all of which may be integrated/removable. The processor 132 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 136. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus 130 can, in examples, comprise means for:
transmitting information 224 indicating whether at least one measurement report 226 for at least one target PSCell 228 of a target SN 166, detectable by the UE 168 at a time that a S-RLF occurred at the UE 168 while the UE 168 was configured to conditionally access the target SN 166, had been transmitted by the UE 168 since the UE 168 was configured to conditionally access the target SN 166 and prior to the S-RLF occurring.

Thus, the apparatus 130 can, in examples, comprise means for:
receiving information 224 indicating whether at least one measurement report 226 for at least one target PSCell 228 of a target SN 166, detectable by a UE 168 at the time of the S-RLF occurring at the UE 168 while the UE 168 was configured to conditionally access the target SN 166, had been transmitted by the UE 168 since the UE was configured to conditionally access the target SN and prior to the S-RLF occurring; and
adjusting, based, at least in part, on the received information 224, at least one parameter 232 configured to control a measurement event at a UE 168 that triggers preparation of at least one target PSCell of the target SN 166 for conditional access by the UE 168.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A user equipment comprising:
at least one processor; and
at least one memory storing instructions that, when executed by the at least one processor, cause the user equipment to perform:
transmitting information indicating whether at least one measurement report for at least one target primary cell of a secondary cell group of a target secondary node, detectable by the user equipment at a time that a secondary radio link failure occurred at the user equipment while the user equipment was configured to conditionally access the target secondary node, had been transmitted by the user equipment since the user equipment was configured to conditionally access the target secondary node and prior to the secondary radio link failure occurring.

2. The user equipment as claimed in claim 1, the user equipment being further caused to perform:
determining that the secondary radio link failure has occurred while the user equipment was configured to conditionally access the target secondary node;
determining the at least one detectable target primary cell of a secondary cell group of the target secondary node and associated radio signal measurements at the time of the secondary radio link failure; and
determining if the at least one measurement report for the at least one detectable target primary cell of a secondary cell group had been transmitted since the user equipment was configured to conditionally access the target secondary node and prior to the secondary radio link failure occurring.

3. The user equipment as claimed in claim 2, wherein determining the at least one detectable target primary cell of a secondary cell group comprises determining N target primary cells of a secondary cell group having strongest radio signal measurements at the time of the secondary radio link failure, wherein N is a positive integer.

4. The user equipment as claimed in claim 1, wherein transmitting the information comprises transmitting at least one SCG Failure Information message.

5. A method comprising:
transmitting, from a user equipment, information indicating whether at least one measurement report for at least one target primary cell of a secondary cell group of a target secondary node, detectable by the user equipment at a time that a secondary radio link failure occurred at the user equipment while the user equipment was configured to conditionally access the target secondary node, had been transmitted by the user equipment since the user equipment was configured to conditionally access the target secondary node and prior to the secondary radio link failure occurring.

6. The method as claimed in claim 5, comprising:
determining that the secondary radio link failure has occurred while the user equipment was configured to conditionally access the target secondary node;
determining the at least one detectable target primary cell of a secondary cell group of the target secondary node and associated radio signal measurements at the time of the secondary radio link failure; and
determining if the at least one measurement report for the at least one detectable target primary cell of a secondary cell group had been transmitted since the user equipment was configured to conditionally access the target secondary node and prior to the secondary radio link failure occurring.

7. The method as claimed in claim 6, wherein determining the at least one detectable target primary cell of a secondary cell group comprises determining N target primary cells of a secondary cell group having strongest radio signal measurements at the time of the secondary radio link failure, wherein N is a positive integer.

8. The method as claimed in claim 5, wherein transmitting the information comprises transmitting at least one SCG Failure Information message.

9.-12. (canceled)

13. An apparatus comprising:
at least one processor; and
at least one memory storing instructions that, when executed by the at least one processor, cause the apparatus to perform:
receiving information indicating whether at least one measurement report for at least one target primary cell of a secondary cell group of a target secondary node, detectable by a user equipment at a time of secondary radio link failure occurring at the user equipment while the user equipment was configured to conditionally access the target secondary node, had been transmitted by the user equipment since the user equipment was configured to conditionally access the target secondary node and prior to the secondary radio link failure occurring; and
adjusting, based, at least in part, on the received information, at least one parameter configured to control a measurement event at a user equipment that triggers preparation of at least one target primary cell of a secondary cell group of the target secondary node for conditional access by the user equipment.

14. The apparatus as claimed in claim 13, the apparatus being further caused to perform:
transmitting information to configure a user equipment with the adjusted at least one parameter.

15. The apparatus as claimed in claim 14, wherein transmitting the information comprises transmitting at least one RRC Reconfiguration message.

16. The apparatus as claimed in claim 13, wherein receiving the information comprises receiving information indicating N target primary cells of a secondary cell group of the target secondary node having strongest radio signal measurements at the time of the secondary radio link failure, wherein N is a positive integer.

17. The apparatus as claimed in claim 13, wherein receiving the information comprises receiving at least one SCG Failure Information message.

18. The apparatus as claimed in claim 13, comprising means for the apparatus being further caused to perform:
determining, based, at least in part, on the received information, that the at least one measurement report had been transmitted by the user equipment for the at least one target primary cell of a secondary cell group of a target secondary node, detectable by the user equipment at the time of the secondary radio link failure occurring at the user equipment, and that the at least one target primary cell of a secondary cell group had not been prepared by the target secondary node for conditional access by the user equipment;
wherein adjusting the at least one parameter comprises adjusting the at least one parameter based, at least in part, on the determination.

19. The apparatus as claimed in claim 13, comprising means for the apparatus being further caused to perform:
determining, based, at least in part, on the received information, that the at least one measurement report had not been transmitted by the user equipment for the at least one target primary cell of a secondary cell group of a target secondary node, detectable by a user equipment at the time of the secondary radio link failure occurring at the user equipment;
wherein adjusting the at least one parameter comprises adjusting the at least one parameter based, at least in part, on the determination.

20.-33. (canceled)
